(19) United States
(12) Patent Application Publication
(10) Pub. No.: US 2024/0000138 A1
(43) Pub. Date: Jan. 4, 2024

(54) AEROSOL-GENERATING COMPONENT

(71) Applicant: NICOVENTURES TRADING LIMITED, London (GB)

(72) Inventors: Richard HEPWORTH, London (GB); Gary FALLON, London (GB); Matthew HODGSON, London (GB)

(21) Appl. No.: 18/255,316

(22) PCT Filed: Dec. 1, 2021
(86) PCT No.: PCT/GB2021/053127

§ 371 Date: May 31, 2023

(30) Foreign Application Priority Data
Dec. 1, 2020 (GB) 2018964.3
Jun. 18, 2021 (GB) 2108812.5

(51) Int. Cl. A24D 1/20; A24F 40/465; A24C 5/01

(52) U.S. Cl. CPC A24D 1/20; A24F 40/465; A24C 5/01; A24D 1/027

(57) ABSTRACT

An aerosol-generating component for use with a non-combustible aerosol provision device includes a first sheet including aerosol-generating material and a second sheet including heating material that is heatable by penetration with a varying magnetic field. A wrapper including paper circumscribes the first and second sheets and has a permeability below 500 Coresta units. Corresponding methods of manufacture are also provided.

### PRIORITY CLAIM

The present application is a National Phase entry of PCT Application No. PCT/GB2021/053127, filed Dec. 1, 2021, which claims priority from GB Application No. 2018.964.3, filed Dec. 1, 2020, and GB Application No. 2108812.5, filed Jun. 18, 2021, each of which is hereby fully incorporated herein by reference.

### TECHNICAL FIELD

The present disclosure relates to an aerosol-generating component for use with a non-combustible aerosol provision device, an article including such a component, and a non-combustible aerosol provision system including an aerosol provision device and such an article. The present disclosure also relates to a method of manufacturing an aerosol-generating component for use with a non-combustible aerosol provision device.

### BACKGROUND

Certain tobacco industry products produce an aerosol during use, which is inhaled by a user. For example, tobacco heating devices heat an aerosol-generating material such as tobacco material to form an aerosol by heating, but not burning, the aerosol-generating material.

### SUMMARY

According to embodiments of the disclosure, there is provided an aerosol-generating component for use with a non-combustible aerosol provision device. The aerosol-generating component comprises: a first sheet comprising aerosol-generating material; a second sheet comprising heating material that is heatable by penetration with a varying magnetic field; and a wrapper comprising paper and circumscribing the first and second sheets, wherein the wrapper has a permeability below 500 Coresta units.

According to embodiments of the disclosure, there is provided an aerosol-generating component for use with a non-combustible aerosol provision device. The aerosol-generating component comprises: a plurality of strips of laminate material, each of the plurality of strips comprising: a first layer comprising aerosol-generating material and a second layer comprising heating material that is heatable by penetration with a varying magnetic field.

According to embodiments of the disclosure, there is provided an aerosol-generating component for use with a non-combustible aerosol provision device. The aerosol-generating component comprises: a first plurality of strips of aerosol-generating material; and a second plurality of strips of heating material that is heatable by penetration with a varying magnetic field.

According to embodiments of the disclosure, there is provided an aerosol-generating component for use with a non-combustible aerosol provision device. The aerosol-generating component comprises: a core section comprising a first aerosol-generating material or a cavity; a sheath section comprising a second aerosol-generating material, wherein the sheath section surrounds the core section; and a boundary material surrounding the core section, wherein the boundary material is between the core section and the sheath section.

According to embodiments of the disclosure, there is provided an article for use with non-combustible aerosol provision device, the article comprising a component as set out above. According to embodiments of the disclosure, there is provided a non-combustible aerosol delivery system comprising a non-combustible aerosol provision device and an article as set out above.

According to embodiments of the disclosure, there is provided a method of manufacturing an aerosol-generating component for use with a non-combustible aerosol provision device, the method comprising: providing a first sheet comprising aerosol-generating material; providing a second sheet comprising heating material that is heatable by penetration with a varying magnetic field; and wrapping the first sheet and the second sheet in a wrapper, wherein the wrapper comprises paper and has a permeability below 500 Coresta units.

According to embodiments of the disclosure, there is provided a method of manufacturing an aerosol-generating component for use with a non-combustible aerosol provision device, the method comprising: forming a sheet of laminate material, the sheet comprising a first layer comprising aerosol-generating material and a second layer comprising heating material that is heatable by penetration with a varying magnetic field; and shredding the sheet to form a plurality of strips of laminate material, each of the plurality of strips comprising: a first layer comprising aerosol-generating material and a second layer comprising heating material that is heatable by penetration with a varying magnetic field.

According to embodiments of the disclosure, there is provided a method of manufacturing an aerosol-generating component for use with a non-combustible aerosol provision device, the method comprising: shredding a first sheet of aerosol-generating material to form a first plurality of strips; and shredding a second sheet of heating material to form a second plurality of strips, wherein the heating material is heatable by penetration with a varying magnetic field.

According to embodiments of the disclosure, there is provided a method of manufacturing an aerosol-generating component for use with a non-combustible aerosol provision device, the method comprising: providing a core section comprising an optional first aerosol-generating material; disposing a boundary material around the core section; and disposing a sheath section around the boundary material, the sheath section comprising a second aerosol-generating material; wherein the boundary material is disposed between the core section and the sheath section.

### BRIEF DESCRIPTION OF THE DRAWINGS

Embodiments of the disclosure will now be described, by way of example only, with reference to accompanying drawings, in which:

FIGS. 1a and 1b are end-on cross-sectional views of aerosol-generating components.

FIG. 2 is a cross-sectional view of an example of the sheets shown in FIG. 1b.

FIG. 3 is a cross-sectional view of another example of the sheets shown in FIG. 1b.

FIGS. 4a and 4b are side-on cross-sectional views of an aerosol-generating component.

FIG. 4c is a plan view of an example of a sheet material.

FIG. 4d is a side-on cross-sectional view of an aerosol-generating component formed using the sheet material shown in FIG. 4c.

FIG. 5 is a side-on cross-sectional view of an aerosol-generating component.

FIG. 6a is a side-on cross-sectional view of an aerosol-generating component.

FIG. 6b is an end-on cross-sectional view of the aerosol-generating component shown in FIG. 6a.

FIG. 6c is an end-on cross-sectional view of an aerosol-generating component.

FIG. 6d is an end-on cross-sectional view of an aerosol-generating component.

FIG. 6e is an end-on cross-sectional view of an aerosol-generating component.

FIG. 7 is a side-on cross-sectional view of an article including an aerosol-generating component.

FIG. 8 is a schematic illustration of a system comprising the article shown in FIG. 7 and an aerosol provision device.

FIG. 9 is a flow diagram illustrating a method of manufacturing an aerosol-generating component.

FIG. 10 is a flow diagram illustrating a method of manufacturing an aerosol-generating component.

FIG. 11 is a flow diagram illustrating a method of manufacturing an aerosol-generating component.

FIG. 12 is a flow diagram illustrating a method of manufacturing an aerosol-generating component.

### DETAILED DESCRIPTION OF THE DRAWINGS

According to the present disclosure, a “non-combustible” aerosol provision system is a system in which a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

A heating material (or susceptor) is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

In one embodiment, the susceptor is in the form of a closed circuit. It has been found that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In some embodiments, the heating material may be a metal such as aluminum, gold or silver, for example in the form of a foil. In some embodiments, the heating material may be a ferromagnetic material. Examples of ferromagnetic materials include metals such as iron, nickel and cobalt, and metal alloys such as certain types of stainless steel. In some embodiments, the heating material may be ferromagnetic stainless steel, for example in the form of a foil. For example, grade 430 stainless steel, or other terrific metals or grades of stainless steel, can be used as the heating material.

In some examples, the heating material may have a thermal conductivity in the range 1 W/(m·K) to 500 W/(m·K). For example, the heating material may have a thermal conductivity in the range 10 W/(m·K) to 60 W/(m·K), 100 W/(m·K) to 250 W/(m·K), 150 W/(m·K) to 250 W/(m·K), or 200 W/(m·K) to 250 W/(m·K). In some examples, the heating material may have a specific heat capacity in the range 100 J/(kg·K) to 1000 J/(kg·K). For example, the heating material may have a specific heat capacity in the range 450 J/(kg·K) to 550 J/(kg·K), 800 J/(kg·K) to 1000 J/(kg·K), or 900 J/(kg·K) to 1000 J/(kg·K).

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

The terms ‘upstream’ and ‘downstream’ used herein are relative terms defined in relation to the direction of mainstream aerosol drawn though an article or device in use.

In the figures described herein, like reference numerals are used to illustrate equivalent features, articles or components.

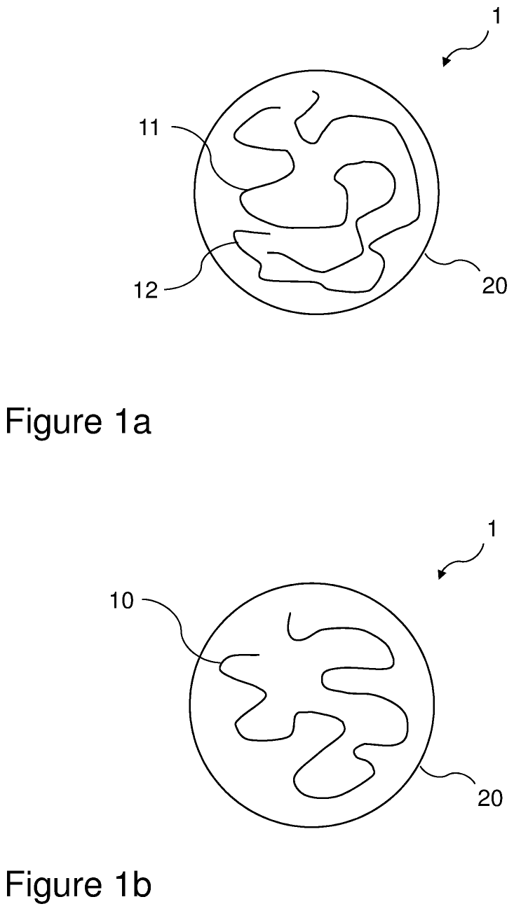

FIG. 1a is an end-on cross-sectional view of an aerosol-generating component 1 comprising first and second sheet materials. The aerosol-generating component is for use in an article for use with a non-combustible aerosol provision device.

The aerosol-generating component 1 comprises a first sheet 11 comprising aerosol-generating material and a second sheet 12 comprising heating material. The aerosol-generating material may be any of the aerosol-generating materials described herein, and the heating material may be any of the heating materials described herein. In the present example, the aerosol-generating material is tobacco material, and the heating material is stainless steel foil. In other examples, the heating material may be aluminum foil. The aerosol-generating material can, for instance, be reconstituted tobacco material. The aerosol-generating material can comprise an aerosol former in an amount between 10% and 30% by weight of the aerosol-generating material, measured on a dry weight basis.

In the present example, a single first sheet and a single second sheet are provided; however, this is not intended to be limiting. In some examples, a plurality of first sheets and/or a plurality of second sheets may be provided.

In the present example, the first sheet 11 and the second sheet 12 are discrete sheets of material. In other words, the first sheet 11 may be in contact with the second sheet 12, but is not bonded or adhered to the second sheet 12. A surface of the first sheet 11 may be in contact with a surface of the second sheet 12 at one or more points. This aids heat transfer between the heating material of the second sheet and the aerosol-generating material of the first sheet, allowing for efficient heating of the aerosol-generating material.

The first sheet may have has a thickness of at least about 100 μm. The first sheet may have a thickness of at least about 120 μm, 140 μm, 160 μm, 180 μm or 200 μm. In some embodiments, the first sheet has a thickness of from about 150 μm to about 300 μm, from about 151 μm to about 299 μm, from about 152 μm to about 298 μm, from about 153 μm to about 297 μm, from about 154 μm to about 296 μm, from about 155 μm to about 295 μm, from about 156 μm to about 294 μm, from about 157 μm to about 293 μm, from about 158 μm to about 292 μm, from about 159 μm to about 291 μm or from about 160 μm to about 290 μm. In some embodiments, the first sheet has a thickness of from about 170 μm to about 280 μm, from about 180 to about 270 μm, from about 190 to about 260 μm, from about 200 μm to about 250 μm or from about 210 μm to about 240 μm. In the present example, the first sheet has a thickness of about 200 μm. The thickness of a sheet can be determined using ISO 534:2011 “Paper and Board-Determination of Thickness”.

The second sheet 12 may have a thickness between about 1 μm and about 150 μm, for example between about 1 μm and about 100 μm, or between about 1 μm and about 50 μm. In the present example, the second sheet 12 has a thickness of about 7 μm. In other examples, the second sheet may have a thickness of about 1 μm, 2 μm, 3 μm, 4 μm, 5 μm, 6 μm, 8 μm, 9 μm or 10 μm. In some embodiments, it can be advantageous to use a thickness of heating material of less than about 50 μm, to improve the heating efficiency of the material when exposed to a varying magnetic field. Without wishing to be bound by theory, it is hypothesized that this is due to an enhancement of the ‘skin effect’ which causes current to flow at the surface of the material and thereby increases resistive heating at the surface of the material.

In some examples, the second sheet may comprise a plurality of apertures, which extend through the thickness of the sheet. For example, the second sheet may be in the form of a mesh. In some examples, the second sheet may comprise a plurality of embossed portions, corrugations, perforations or deformations.

In some examples, the first sheet may comprise a plurality of apertures. In some examples, the first sheet may comprise a plurality of embossed portions, corrugations, perforations or deformations.

In some examples, the total area of the first sheet is greater than the total area of the second sheet. In some examples, the total area of the first sheet is less than the total area of the second sheet.

In the present example, the aerosol-generating component 1 is substantially cylindrical with a substantially circular cross-section, as shown in FIG. 1a. In other examples, the aerosol-generating component may have other cross-sections, such as an oval or elliptical cross-section. In some examples, the aerosol-generating component may have a rectangular, square, triangular, or star-shaped cross-section. In some examples, the aerosol-generating component may have an irregular cross-section.

In the present example, the aerosol-generating component 1 is elongate and has a longitudinal axis (not shown). The first sheet 11 and the second sheet 12 extend substantially parallel to the longitudinal axis of the aerosol-generating component 1.

The first sheet 11 and the second sheet 12 can be formed into the aerosol-generating component 1 by crimping and gathering the first and second sheets 11, 12.

The length of the aerosol-generating component 1 may be between about 8 mm and about 150 mm. In the present example, the aerosol-generating component has a length of about 12 mm.

The width (or diameter) of the aerosol-generating component may be between about 4 mm and about 10 mm. In the present example, the aerosol-generating component has a width, or diameter, of about 7.3 mm.

The aerosol-generating component 1 further comprises a wrapper 20 circumscribing the first and second sheets. The wrapper 20 surrounds the first sheet 11 and the second sheet 12, thereby enclosing the first sheet 11 and the second sheet 12. This may help to prevent the first sheet and the second sheet from separating. The wrapper 20 may also help to direct air and/or aerosol through the component 1.

In the present example, the wrapper 20 comprises paper. The wrapper 20 has a permeability below 500 Coresta units (CU). In some examples, the wrapper may have a permeability below 400 CU, 300 CU, 200 CU or 100 CU. Using a wrapper with permeability below 500 Coresta units reduces the flammability of the wrapper, which minimizes the risk of the wrapper igniting, for instance if a consumer were to attempt to light the component 1 using a flame. In the present example, the wrapper 20 has a permeability of about 0 CU. In other examples, the wrapper may have a permeability of 30 CU, 40 CU, 60 CU, 70 CU or 80 CU. In addition or as an alternative to a paper having a permeability below 500 CU, the wrapper 20 can comprise a burn-retardant additive. The burn-retardant additive may, for instance, prevent or limit combustion of the wrapper 20 when exposed to a flame.

In some examples, the wrapper may consist of paper only. In other examples, the wrapper may comprise a metal layer in addition to the paper. For example, the wrapper may comprise a layer of aluminum foil. Such a metal layer may assist in transferring heat evenly throughout the aerosol-generating material in the component. This may help to prevent any particular region of the aerosol-generating material from reaching its combustion temperature.

The metal layer may have a thickness between about 1 μm and about 50 μm. For instance, in some examples the metal layer may have a thickness of 7 μm. In other examples, the metal layer may have a thickness of 1 μm, 2 μm, 3 μm, 4 μm, 5 μm, 6 μm, 8 μm, 9 μm or 10 μm.

FIG. 1b is an end-on cross-sectional view of an aerosol-generating component 1 comprising a laminate material 10. The aerosol-generating component is for use in an article for use with a non-combustible aerosol provision device.

The aerosol-generating component 1 shown in FIG. 1b is similar to the aerosol-generating component shown in FIG. 1a, and comprises a first sheet comprising aerosol-generating material, and a second sheet comprising heating material. The aerosol-generating material may be any of the aerosol-generating materials described herein, and the heating material may be any of the heating materials described herein. In the present example, the aerosol-generating material is tobacco material, and the heating material is stainless steel foil. In other examples, the heating material may be aluminum foil. The aerosol-generating material can, for instance, be reconstituted tobacco material. The aerosol-generating material can comprise an aerosol former in an amount between 10% and 30% by weight of the aerosol-generating material, measured on a dry weight basis.

In the present example, the first sheet and the second sheet are bonded together to form a laminate material 10. A surface of the first sheet may therefore be completely in contact with a surface of the second sheet, or in close proximity to the surface of the second sheet. This relatively large amount of contact or proximity between the first sheet and the second sheet aids heat transfer between the heating material of the second sheet and the aerosol-generating material of the first sheet, allowing for efficient heating of the aerosol-generating material.

The aerosol-generating component 1 shown in FIG. 1b further comprises a wrapper 20 circumscribing the first and second sheets. The wrapper 20 may be the same as the wrapper described above in relation to FIG. 1a.

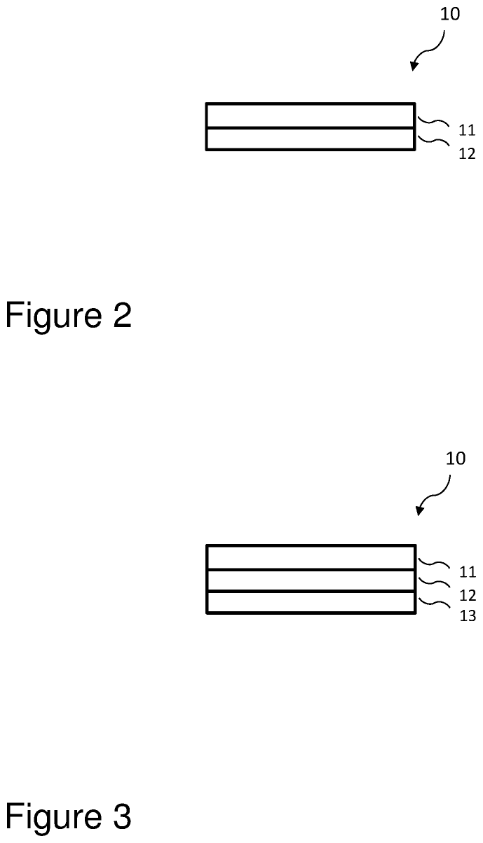

FIG. 2 shows a cross-sectional view of an example of the laminate material 10 shown in FIG. 1b. The first sheet (or layer) 11 and the second sheet (or layer) 12 are bonded together. In the present example, the first sheet and the second sheet are bonded together by an adhesive (not shown). The adhesive may be an adhesive such as polyvinyl acetate (PVA) or ethylene-vinyl acetate (EVA). In other examples, adhesives such as a polysaccharide-based adhesive may be used. The adhesive can, for instance, comprise guar gum, pectin, an alginate or a combination thereof. The alginate can, for instance, comprise sodium alginate.

FIG. 3 shows a cross-sectional view of another example of the laminate material 10 shown in FIG. 1b. In this example, the laminate material 10 includes a third sheet (or layer) 13 in addition to the first sheet (or layer) 11 and the second sheet (or layer) 12.

The sheets are arranged so that the second sheet 12 is disposed between the first sheet 11 and the third sheet 13. The third sheet 13 comprises an aerosol-generating material, which may be the same as, or different from, the aerosol-generating material of the first sheet 11. In the present example, the aerosol-generating material of the third sheet 13 is tobacco material.

The second sheet 12 is bonded to the first sheet 11 and the third sheet 13. In the present example, the second sheet 12 is bonded to the first sheet 11 and the third sheet 13 by an adhesive (not shown) such as those described above.

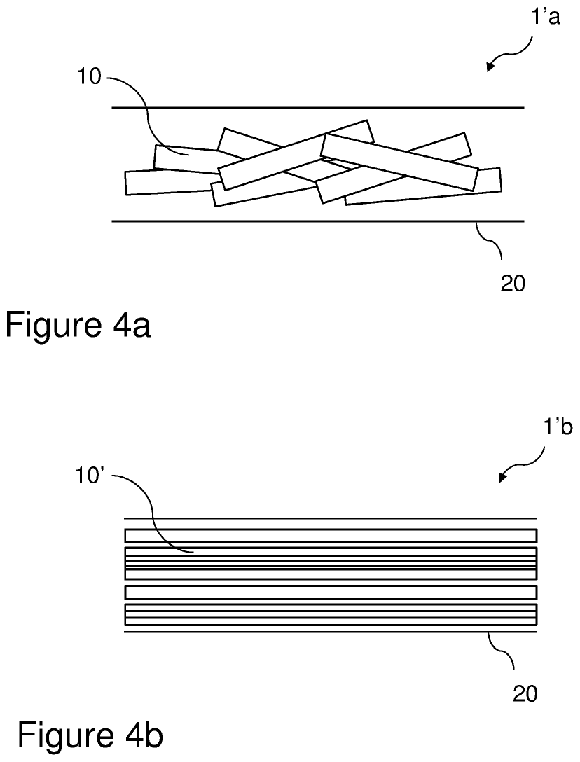

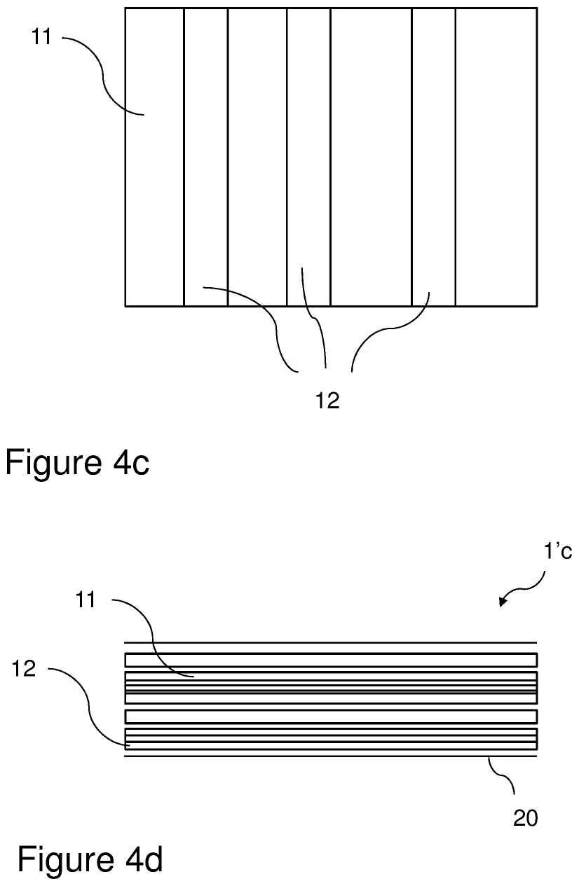

FIGS. 4a and 4b show side-on cross-sectional views of respective aerosol-generating components 1′a and 1′b, each comprising a plurality of strips of laminate material. The aerosol-generating components 1′a and 1′b are for use in an article for use with a non-combustible aerosol provision device.

The aerosol-generating component 1′a and 1′b comprise a plurality of strips (or strands) of laminate material 10, 10′. The strips of laminate material 10 of FIG. 4a are shorter than the length of the component 1′a. The strips of laminate material 10 of FIG. 4a are disposed at a variety of orientations within the component 1′a. The strips of laminate material 10′ of FIG. 4b extend the full length, or substantially the full length, of the component 1′b. The strips of laminate material 10′ of FIG. 4b are disposed parallel, or substantially parallel, to the longitudinal axis (not shown) of the component 1′b.

Each of the plurality of strips 10, 10′ comprises a first layer comprising aerosol-generating material and a second layer comprising heating material. The aerosol-generating material may be any of the aerosol-generating materials described herein, and the heating material may be any of the heating materials described herein. In the present example, the aerosol-generating material is tobacco material, and the heating material is stainless steel foil. In other examples, the heating material may be aluminum foil. The aerosol-generating material can, for instance, be reconstituted tobacco material. The aerosol-generating material can comprise an aerosol former in an amount between 10% and 30% by weight of the aerosol-generating material, measured on a dry weight basis.

In the present example, the first layer and the second layer are secured together by an adhesive, as described above with reference to FIGS. 2 and 3. When viewed in cross-section, the strips 10, 10′ may have a similar structure to the structures shown and described in relation to FIGS. 2 and 3.

The strips of laminate material 10, 10′ are circumscribed by a wrapper 20. The wrapper 20 surrounds the strips of laminate material 10, 10′, thereby enclosing the strips of laminate material 10, 10′. This may help to prevent the strips of laminate material from separating. The wrapper 20 may also help to direct air and/or aerosol through the components 1′a, 1′b. The wrapper may be the same as the wrapper described above in relation to FIGS. 1a and 1b.

In the present example, the aerosol-generating components 1′a, 1′b are substantially cylindrical and have a longitudinal axis (not shown).

The strips may have an aspect ratio of 1:1. In an embodiment, the strips are elongate, i.e. having an aspect ratio of greater than 1:1. In some embodiments, the strips have an aspect ratio of from about 1:5 to about 1:16, or about 1:5, 1:6, 1:7, 1:8, 1:9, 1:10, 1:11 or 1:12. Where the aspect ratio of a strip is greater than 1:1, the strip comprises a longitudinal dimension, or length, extending between a first end of the strip and a second end of the strip. In the present example, the strips are rectangular in shape, however the strips may be formed in other shapes.

A first dimension, or cut width, of the strips is between about 0.9 mm and about 2 mm. In one embodiment, the cut width of the strips is between about 1 mm and 1.5 mm.

The strips may be formed by shredding a sheet of laminate material. The sheet of laminate material may be cut width-wise, for example in a cross-cut type shredding process, to define a cut length for the strips of laminate material, in addition to a cut width. The cut length of the shredded laminate material can be at least 5 mm, for instance at least 10 mm, or at least 20 mm. The cut length of the shredded laminate material can be less than 60 mm, less than 50 mm, or less than 40 mm.

In some embodiments, at least one of the plurality of strips of laminate material has a length greater than about 10 mm. At least one of the plurality of strips of laminate material can alternatively or in addition have a length between about 10 mm and about 60 mm, or between about 20 mm and about 50 mm. Each of the plurality of strips of laminate material can have a length between about 10 mm and about 60 mm, or between about 20 mm and about 50 mm.

The sheet or shredded sheet of laminate material has a thickness of at least about 100 μm. The sheet or the shredded sheet may have a thickness of at least about 120 μm, 140 μm, 160 μm, 180 μm or 200 μm. In some embodiments, the sheet or shredded sheet has a thickness of from about 150 μm to about 300 μm, from about 151 μm to 35 about 299 μm, from about 152 μm to about 298 μm, from about 153 μm to about 297 μm, from about 154 μm to about 296 μm, from about 155 μm to about 295 μm, from about 156 μm to about 294 μm, from about 157 μm to about 293 μm, from about 158 μm to about 292 μm, from about 159 μm to about 291 μm or from about 160 μm to about 290 μm. In some embodiments, the sheet or shredded sheet has a thickness of from about 170 μm to about 280 μm, from about 180 to about 270 μm, from about 190 to about 260 μm, from about 200 μm to about 250 μm or from about 210 μm to about 240 μm.

The thickness of the sheet or shredded sheet may vary between the first and second surfaces of the sheet. In some embodiments, an individual strip or piece of the laminate material has a minimum thickness over its area of about 100 μm. In some cases, an individual strip or piece of the laminate material has a minimum thickness over its area of about 0.05 mm or about 0.1 mm. In some cases, an individual strip, strand or piece of the laminate material has a maximum thickness over its area of about 1.0 mm. In some cases, an individual strip or piece of the laminate material has a maximum thickness over its area of about 0.5 mm or about 0.3 mm.

FIG. 4c shows a plan view of an example of a sheet material which may be formed into a rod for use in an aerosol-generating component. FIG. 4d shows a side-on cross-sectional view of an aerosol-generating component formed using the sheet material shown in FIG. 4c.

The sheet material comprises a continuous sheet of aerosol-generating material 11, in the present example tobacco material. Strips of heating material 12, in the present example aluminum foil, are disposed on top of the sheet of aerosol-generating material 11. The strips of heating material 12, in the present example, are in contact with the aerosol-generating material 11, but are not bonded or adhered to the aerosol-generating material 11.

The sheet material of FIG. 4c can be crimped and gathered to form a rod, or may be cut, for instance into longitudinal strips, to form a rod. When cut to form strips and assembled into a rod, the strips of heating material 12 are distributed throughout the aerosol-generating material 11, as shown in FIG. 4d. This ensures good thermal contact between the aerosol-generating material 11 and the heating material 12, which aids heat transfer from the heating material to the aerosol-generating material. In some embodiments, the strips of heating material 12 are disposed close to the outer surface of the aerosol-generating component 1′c. This can assist with inductive heating of the heating material by a non-combustible aerosol provision device in use.

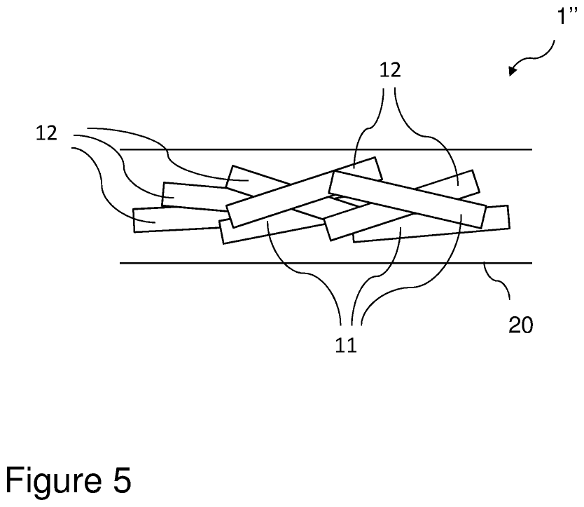

FIG. 5 shows a side-on cross-sectional view of a cross-sectional view of an aerosol-generating component 1″. The aerosol-generating component is for use in an article for use with a non-combustible aerosol provision device.

The aerosol-generating component 1″ comprises a first plurality of strips (or strands) of aerosol-generating material 11, and a second plurality of strips (or strands) of heating material 12. The aerosol-generating material may be any of the aerosol-generating materials described herein, and the heating material may be any of the heating materials described herein. In the present example, the aerosol-generating material is tobacco material, and the heating material is stainless steel foil. In other examples, the heating material may be aluminum foil.

The first strips 11 and the second strips 12 are circumscribed by a wrapper 20. The wrapper surrounds the first strips 11 and the second strips 12, thereby enclosing the first strips 11 and the second strips 12. This may help to prevent the first strips and the second strips from separating. The wrapper 20 may also help to direct air and/or aerosol through the component 1. The wrapper may be the same as the wrapper described above in relation to FIG. 1a.

In the present example, the aerosol-generating component 1″ is substantially cylindrical and has a longitudinal axis (not shown). The first strips 11 and the second strips 12 are randomly oriented, but are substantially aligned with the longitudinal axis of the aerosol-generating component 1″. In alternative embodiments, the first strips 11 and second strips 12 can be provided in a manner similar to that illustrated in FIG. 4b, wherein the strips 11, 12 extend parallel or substantially parallel to the longitudinal axis of the component 1″ and each extend the full length, or substantially the full length, of the component 1″.

The first strips 11 are dispersed within the second strips 12. In other words, the first strips 11 and the second strips 12 are intermixed. This ensures good thermal contact between the aerosol-generating material of the first strips 11 and the heating material of the second strips 12, which aids heat transfer from the heating material to the aerosol-generating material.

The first strips 11 may have dimensions (e.g. length, width, thickness) similar to the dimensions described above in relation to the strips shown in FIGS. 4a and 4b. A detailed description of the dimensions for the first strips 11 is therefore omitted.

The second strips 12 may have lengths and/or widths similar to the lengths and widths described above in relation to the strips shown in FIGS. 4a and 4b. A detailed description of the lengths and/or widths for the second strips is therefore omitted.

The second strips 12 may have a thickness between about 1 μm and about 150 μm, for example between about 1 μm and about 100 μm, or between about 1 μm and about 50 μm. In the present example, each of the second strips has a thickness of about 7 μm. In other examples, each of the second strips may have a thickness of 1 μm, 2 μm, 3 μm, 4 μm, 5 μm, 6 μm, 8 μm, 9 μm or 10 μm.

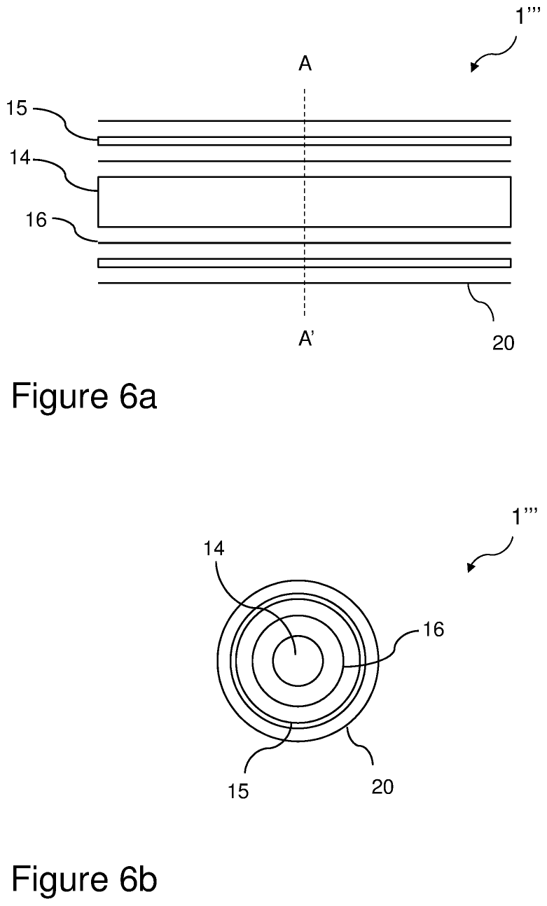

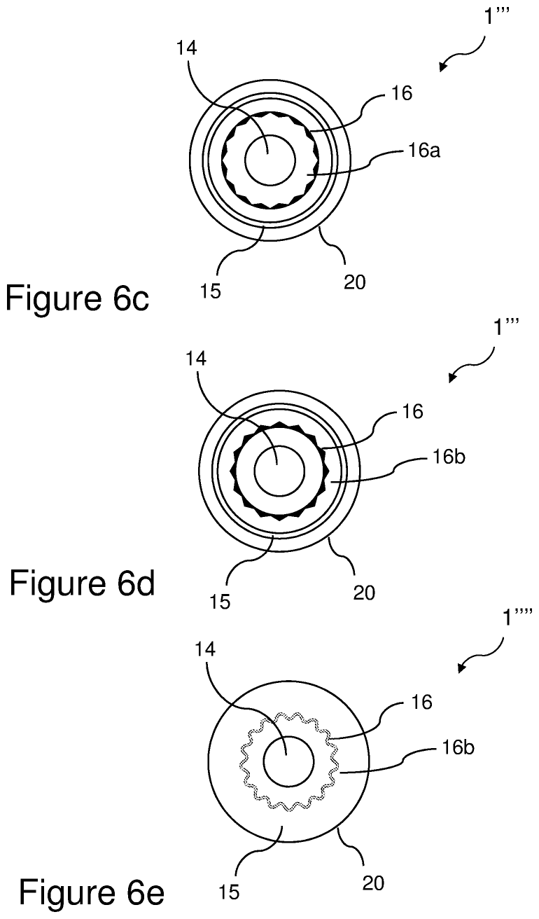

FIG. 6a shows a side-on cross-sectional view of an aerosol-generating component 1′″. FIG. 6b shows an end-on cross-sectional view of the aerosol-generating component 1′″ shown in FIG. 6a. The aerosol-generating component is for use in an article for use with a non-combustible aerosol provision device. Alternatively, the aerosol-generating component 1′″ can be used directly within a non-combustible aerosol provision device without being incorporated into an article.

The aerosol-generating component 1′″ comprises a core section 14 comprising a first aerosol-generating material, and a sheath section 15 comprising a second aerosol-generating material. The sheath section 15 surrounds the core section 14. In the present example, the sheath section 15 extends completely around the core section 14. In other examples, the sheath section may extend only partially around the core section. In alternative examples, the core section 14 can be omitted.

The first aerosol-generating material and the second aerosol-generating material may be any of the aerosol-generating materials described herein. In the present example, each of the first aerosol-generating material and the second aerosol-generating material comprises tobacco material. In some examples, the second aerosol-generating material may comprise a heating material, for instance particles or strips of a heating material distributed within the second aerosol-generating material.

A characteristic of the first aerosol-generating material may be different from a characteristic of the second aerosol-generating material. The characteristic may be a characteristic such as density, type, or flavor. For example, the first aerosol-generating material and the second aerosol-generating material may include different flavors. Alternatively, only one of the first aerosol-generating material and the second aerosol-generating material may include a flavor. In cases where the first aerosol-generating material and the second aerosol-generating material comprise tobacco material, the first aerosol-generating material and the second aerosol-generating material may comprise different types of tobacco material. For example, the first aerosol-generating material may comprise tobacco such as lamina tobacco and the second aerosol-generating material may comprise reconstituted tobacco sheet. For instance, the first aerosol-generating material may comprise cut rag tobacco formed using, for instance, lamina tobacco material. The second aerosol-generating material may comprise reconstituted tobacco sheet in the form of strips of aerosol-generating material as described herein.

The aerosol-generating component 1′″ further comprises a boundary material, in the present case an inner wrapper 16, surrounding the core section 14. In the present example, the boundary material extends completely around the core section 14. In other examples, the boundary material may extend only partially around the core section. The boundary material 16 defines a boundary between the core section 14 and the sheath section 15.

In the present example, the aerosol-generating component 1′″ further comprises an outer wrapper 20 circumscribing the core section 14, the boundary material 16 and the sheath section 15. The outer wrapper 20 surrounds the core section 14, the boundary material 16 and the sheath section 15, thereby enclosing the core section 14, the boundary material 16 and the sheath section 15. This may help to prevent the core section 14, the boundary material 16 and the sheath section 15 from separating. The wrapper 20 may also help to direct air and/or aerosol through the component 1′″.

In the present example, the aerosol-generating component 1′″ is substantially cylindrical with a substantially circular cross-section, as shown in FIG. 6b. In other examples, the aerosol-generating component may have other cross-sections, such as an oval or elliptical cross-section. In some examples, the aerosol-generating component may have a rectangular, square, triangular, or star-shaped cross-section. In some examples, the aerosol-generating component may have an irregular cross-section.

In the present example, the aerosol-generating component 1′″ is elongate and has a longitudinal axis (not shown). The core section 14, the boundary material 16 and the sheath section 15 all extend substantially parallel to the longitudinal axis of the component 1′″.

In some examples, the core section 14 comprises a rod of the first aerosol-generating material and the sheath section 15 comprises a sheet of the second aerosol-generating material. In the present example, the core section 14 comprises a rod of tobacco material and the sheath section 15 comprises a sheet of tobacco material. In other examples, the core section 14 can comprise a rod formed from one or more crimped and gathered sheets, similar to the arrangements described with reference to either FIG. 1a or FIG. 1b, with the first material comprising aerosol-generating material. The sheath section 15 can also be formed from one or more crimped and gathered sheets, or may be formed from any of the strips described herein, for instance including strips of the second aerosol-generating material.

In some examples, the core section 14 comprises a plurality of strips of aerosol-generating material and/or heating material and/or the sheath section 15 comprises a plurality of strips of aerosol generating material and/or heating material, the strips for instance being the relevant strips described with reference to FIGS. 4a, 4b and 5 herein. The boundary material 16 can comprise heating material as described here, and in this way be used to heat the core section 14 and sheath section 15 simultaneously. In the case that the core section 14 and the sheath section 15 consist of aerosol-generating material, for instance without including any heating material, the boundary material 16 can provide the sole source of heat into the core section 14 and sheath section 15. Alternatively, the core and/or sheath section can comprise separate heating material, in addition to that provided in the boundary material.

In the present example, the boundary material 16 is in contact with both the first aerosol-generating material and the second aerosol-generating material. This aids heat transfer between the materials of the component 1′″.

The core section can be substantially cylindrical, and can have a diameter between about 2 mm and about 6 mm, for instance between about 3 mm and about 6 mm, or between about 4 mm and about 6 mm. In the present example, the core section 14 is substantially cylindrical, with a diameter of about 5 mm. In other examples, the core section 14 can have other cross-sectional shapes, such as an ellipse, an oval, a triangle or square. This can mean that the lateral dimension of the core and sheath sections can vary with radial location around the sections, which can provide more varied exposure of the first and second aerosol-generating materials to heat and therefore assist with more even aerosol-generating during a period of use.

The core and the sheath sections can have about the same volume. For instance, for a component with a diameter of about 7.3 mm, a core of diameter 5 mm results in a core and a sheath section with approximately the same volume, meaning that these sections can, for instance, be heated effectively via boundary material comprising heating material as described herein. The core section 14 can have an outer diameter which is between about 65% and about 75% of the outer diameter of the sheath section 15. The boundary material, at its maximum diameter, can have a diameter which is between about 65% and about 75% of the maximum outer diameter of the sheath section 15. In alternative embodiments, the core diameter can be between 6 mm and 7 mm, for instance allowing for a sheet material to be used as the sheath section.

Alternatively, the core section 14 can have an outer diameter which is about half of the outer diameter of the sheath section 15. The core section 14 can have an outer diameter which is, for instance, between about 30% and about 70% of the outer diameter of the sheath section 15, or between about 40% and about 60% of the outer diameter of the sheath section 15, or between about 45% and 55% of the outer diameter of the sheath section 15. The boundary material, at its maximum diameter, can have a diameter which is between about 30% and about 70%, or between about 40% and about 60%, or between about 45% and about 55% of the maximum outer diameter of the sheath section 15. The core section 14 can include aerosol-generating material with a lower thermal conductivity than the sheath section 15. This can, for instance, mean that where the sheath section 15 has a larger volume than the core section 14, heat distribution within the component 1′″ as a whole during use is more uniform.

The sheath section can be substantially tubular, and can have a thickness between about 100 μm and about 300 μm when provided as a sheet material in a substantially single thickness, or can have a thickness of about 1 mm to about 5 mm when provided in other forms. In the present example, the sheath section 13 is a sheet of aerosol-generating material having a thickness of about 200 μm.

The boundary material 16 can have a thickness between about 1 μm and about 500 μm, for instance between about 50 μm about 450 μm. In some examples the thickness of the boundary material is between about 1 μm and about 150 μm or between about 100 μm and about 400 μm. In the present example, the boundary material 16 is a sheet of material having a thickness of about 50 μm. In other examples, the boundary material 16 is a sheet of material having a thickness of about 150 μm, about 200 μm, about 250 μm, about 300 μm, about 350 μm, about 400 μm or about 450 μm. The boundary material 16 can comprise a sheet of heating material, for example a ferromagnetic heating material. In the present example, the boundary material 16 is a continuous sheet of stainless steel foil. In other examples, the boundary material 16 may be a sheet of aluminum foil or provided in other forms, such as a mesh formed by wires of heating material. The wires can, for instance, have a diameter between about 50 μm and about 500 μm. Such a mesh can be provided with parallel wires extending laterally and longitudinally across the mesh, with a spacing of between about 0.3 mm and about 2 mm, for instance between about 0.5 mm and about 1.5 mm or about 1 mm. The mesh may be provided with a backing sheet material, such as paper, to which the mesh is adhered.

In some examples, the boundary material 16 may be a sheet of material comprising a plurality of apertures, which extend through the thickness of the sheet. For example, the boundary material 16 may be in the form of a perforated or porous sheet. Such arrangements may allow aerosol generated by the first aerosol-generating material and aerosol generated by the second aerosol-generating material to mix within the component. In some examples, the boundary material 16 may comprise a plurality of embossed portions, corrugations, perforations or deformations.

The boundary material 16 can be formed into a continuous tube of sheet material and/or heating material and, in manufacture of the component 1′″, the continuous tube can be fed into a source of the second aerosol-generating material. For instance, the second aerosol-generating material can be a plurality of strips of aerosol-generating material, such as reconstituted tobacco material, and the boundary material 16 can be fed as a continuous tube into a continuous supply of the strips and then wrapped in the outer wrapper 20. The boundary material 16 can be fed as an elongate sheet with is bent to form a tube and then welded and/or otherwise mechanically and/or electrically connected at the seam in an ‘online’ process, shortly before the tube is inserted into the second aerosol-generating material. The tube can be filled or partially filled with the first aerosol-generating material during this process (i.e. immediately prior to forming the tube from the elongate sheet of boundary material), or once the process is complete and the tube is embedded within the second aerosol-generating material. Alternatively, the tube can remain hollow and form a boundary between the second aerosol-generating material and an internal cavity extending through the component 1′″.

In some examples, the aerosol-generating component may comprise one or more airflow pathways defined by the inner wrapper. The airflow pathways may extend along an longitudinal axis of the aerosol-generating component, and may allow flow of air and/or aerosol in a direction substantially parallel to the longitudinal axis of the aerosol-generating component.

In some examples, the boundary material may have a corrugated inner surface, as shown in FIG. 6c. In this example, the inner surface of the boundary material 16 comprises a plurality of depressions (or grooves) 16a spaced around the circumference of the boundary material 16. Each of the depressions 16a forms a space between the inner surface of the boundary material 16 and an outer surface of the core section 14. Each of these spaces extends longitudinally and defines an airflow pathway.

In some examples, the boundary material 16 may have a corrugated outer surface, as shown in FIG. 6d. In this example, the outer surface of the boundary material 16 comprises a plurality of depressions (or grooves) 16b spaced around the circumference of the boundary material 16. Each of the depressions 16b forms a space between the outer surface of the boundary material 16 and an inner surface of the sheath section 15. Each of these spaces extends longitudinally and defines an airflow pathway.

In some examples, the boundary material 16 is a corrugated sheet such as a corrugated heating material sheet with aerosol-generating material on both the inner and outer sides of the boundary material 16, as illustrated in FIG. 6e in which the article 1′″ includes a boundary material 16 in this form. The corrugations in this example and in other corrugated sheet examples can assist with increasing the surface area of boundary material 16 which comes into contact with the core 14 and sheath 15, for instance aerosol-generating material in the core and/or sheath, inside and/or outside of the boundary material 16. The corrugations can also assist with adding structural strength to the boundary material 16. The boundary material can be heating material sheet, or other sheet materials, such as plant based material sheet, tobacco material sheet, sheet material containing aerosol-former, sheet material containing flavorant, gelled sheet or similar. In some examples, the corrugated sheet material is a ferritic sheet material, such as corrugated ferritic stainless steel sheet having a thickness between about 20 μm and about 500 μm, for instance between about 40 μm and about 300 μm.

In some examples, the boundary material 16 may comprise a plurality of layers. One or more of the plurality of layers may have a corrugated surface in order to form longitudinally extending spaces within the boundary material 16. Each of the spaces defines an airflow pathway within the boundary material.

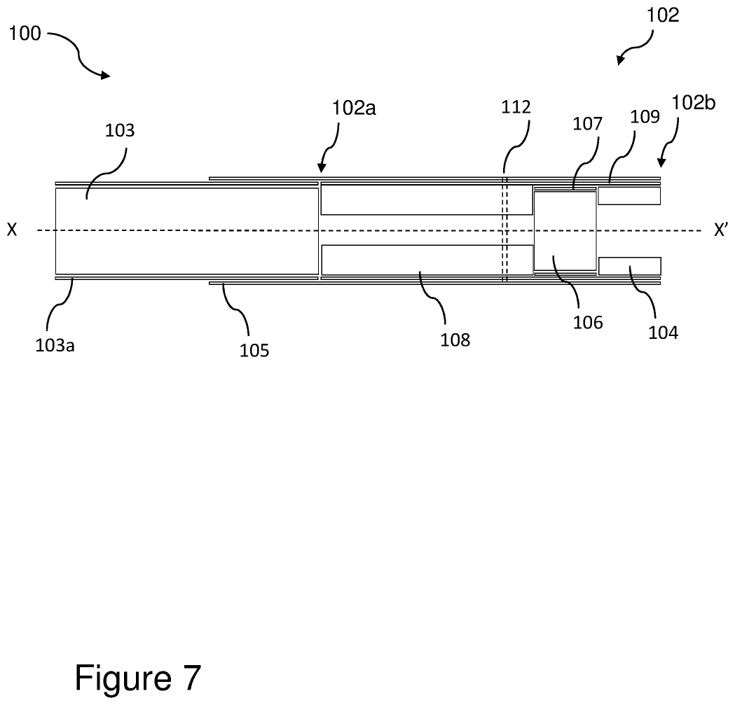

FIG. 7 is a side-on cross-sectional view of an article 100 for use with a non-combustible aerosol provision device.

The article 100 comprises a mouthpiece 102, and an aerosol-generating section connected to the mouthpiece 102. In the present example, the aerosol generating section comprises an aerosol-generating component 103, which may be any of the aerosol-generating components described herein. In the present example, the aerosol-generating component 103 includes a wrapper 103a.

In some examples, the article may comprise a carbon tip (not shown) which can be combusted to provide heat to the aerosol-generating component. When the article is inserted into a non-combustible aerosol provision device, the carbon tip may be heated by a heater of the non-combustible aerosol provision device to ignite the carbon tip. In such articles, the heating material (e.g. aluminum foil or stainless steel foil) of the aerosol-generating component may help to distribute heat from the carbon tip throughout the aerosol-generating material of the aerosol-generating component. Such an article can also be inserted into a non-combustible aerosol provision device comprising an induction coil or similar arrangement for forming a varying magnetic field, and in this case the heating material acts as a susceptor and need not be heated via the carbon tip.

A tipping paper 105 is wrapped around the full length of the mouthpiece 102 and over part of the aerosol-generating component 103 and has an adhesive on its inner surface to connect the mouthpiece 102 and aerosol-generating component 103. In the present example, the aerosol-generating component 103 includes a wrapper 103a, which forms a first wrapping material, and the tipping paper 105 forms an outer wrapping material which extends at least partially over the aerosol-generating component 103 to connect the mouthpiece 102 and aerosol-generating component 103. In some examples, the tipping paper can extend only partially over the aerosol-generating component 103.

In the present example, the tipping paper 105 extends 5 mm over the aerosol-generating component 103 but it can alternatively extend between 3 mm and 10 mm over the aerosol-generating component 103, or between 4 mm and 6 mm, to provide a secure attachment between the mouthpiece 2 and aerosol-generating component 103. The tipping paper can have a basis weight greater than 20 gsm, for instance greater than 25 gsm, or greater than 30 gsm, for example 37 gsm. These ranges of basis weights have been found to result in tipping papers having acceptable tensile strength while being flexible enough to wrap around the article 100 and adhere to itself along a longitudinal lap seam on the paper. In the present example, the outer circumference of the tipping paper 105, once wrapped around the mouthpiece 102, is about 23 mm.

The mouthpiece 102 includes a cooling section 108, also referred to as a cooling element, positioned immediately downstream of and adjacent to the aerosol-generating component 103. In the present example, the cooling section 108 is in an abutting relationship with the aerosol-generating component 103. The mouthpiece 102 also includes, in the present example, a body of material 106 downstream of the cooling section 108, and a hollow tubular element 104 downstream of the body of material 106, at the mouth end of the article 100.

The cooling section 108 comprises a hollow channel, having an internal diameter of between about 1 mm and about 4 mm, for example between about 2 mm and about 4 mm. In the present example, the hollow channel has an internal diameter of about 3 mm. The hollow channel extends along the full length of the cooling section 108. In the present example, the cooling section 108 comprises a single hollow channel. In alternative embodiments, the cooling section can comprise multiple channels, for example, 2, 3 or 4 channels. In the present example, the single hollow channel is substantially cylindrical, although in alternative embodiments, other channel geometries/cross-sections may be used. The hollow channel can provide a space into which aerosol drawn into the cooling section 108 can expand and cool down. In all embodiments, the cooling section is configured to limit the cross-sectional area of the hollow channel/s, to limit tobacco displacement into the cooling section, in use.

The cooling section 108 can have a wall thickness in a radial direction, which can be measured, for example, using a caliper. The wall thickness of the cooling section 108, for a given outer diameter of cooling section, defines the internal diameter for the cavity surrounded by the walls of the cooling section 108. The cooling section 108 can have a wall thickness of at least about 1.5 mm and up to about 2 mm. In the present example, the cooling section 108 has a wall thickness of about 1.5 mm.

The cooling section 108 is formed from filamentary tow. Other constructions can be used, such as a plurality of layers of paper which are parallel wound, with butted seams, to form the cooling section 108; or spirally wound layers of paper, cardboard tubes, tubes formed using a papier-mâché type process, molded or extruded plastic tubes or similar. The cooling section 108 is manufactured to have a rigidity that is sufficient to withstand the axial compressive forces and bending moments that might arise during manufacture and whilst the article 100 is in use.

The wall material of the cooling section 108 can be relatively non-porous, such that at least 90% of the aerosol generated by the aerosol-generating component 103 passes longitudinally through the one or more hollow channels rather than through the wall material of the cooling section 108. For instance, at least 92% or at least 95% of the aerosol generated by the aerosol-generating component 103 can pass longitudinally through the one or more hollow channels.

The filamentary tow forming the cooling section 108 can have a total denier of less than 45,000 such as less than 42,000. This total denier has been found to allow the formation of a cooling section 108 which is not too dense. In some embodiments, the total denier is at least 20,000 such as at least 25,000. In some embodiments, the filamentary tow forming the cooling section 108 has a total denier between 25,000 and 45,000, such as between 35,000 and 45,000. In some embodiments the cross-sectional shape of the filaments of tow are ‘Y’ shaped, although in other embodiments other shapes such as ‘X’ shaped filaments can be used.

The filamentary tow forming the cooling section 108 can have a denier per filament of greater than 3. This denier per filament has been found to allow the formation of a tubular element 104 which is not too dense. In some embodiments, the denier per filament is at least 4, such as at least 5. In some embodiments, the filamentary tow forming the hollow tubular element 104 has a denier per filament between 4 and 10, such as between 4 and 9. In one example, the filamentary tow forming the cooling section 108 has an 8Y40,000 tow formed from cellulose acetate and comprising 18% plasticizer, for instance triacetin.

In some embodiments, the density of the material forming the cooling section 108 is at least about 0.20 grams per cubic centimeter (g/cc), such as at least about 0.25 g/cc. In some embodiments, the density of the material forming the cooling section 108 is less than about 0.80 grams per cubic centimeter (g/cc), such as less than 0.6 g/cc. In some embodiments, the density of the material forming the cooling section 108 is between 0.20 and 0.8 g/cc, such as between 0.3 and 0.6 g/cc, or between 0.4 g/cc and 0.6 g/cc or about 0.5 g/cc. These densities have been found to provide a good balance between improved firmness afforded by denser material and minimizing the overall weight of the article. For the purposes of the present disclosure, the “density” of the material forming the cooling section 108 refers to the density of any filamentary tow forming the element with any plasticizer incorporated. The density may be determined by dividing the total weight of the material forming the cooling section 108 by the total volume of the material forming the cooling section 108, wherein the total volume can be calculated using appropriate measurements of the material forming the cooling section 108 taken, for example, using calipers. Where necessary, the appropriate dimensions may be measured using a microscope.

In some embodiments, the length of the cooling section 108 is less than about 30 mm. For example, the length of the cooling section 108 is less than about 25 mm. In one particular example, the length of the cooling section 108 is less than about 20 mm. In addition, or as an alternative, the length of the cooling section 108 can be at least about 10 mm. In some embodiments, the length of the cooling section 108 is at least about 15 mm. In some embodiments, the length of the cooling section 108 is from about 15 mm to about 20 mm, such as from about 16 mm to about 19 mm. In the present example, the length of the cooling section 108 is 19 mm.

The cooling section 108 is located around and defines an air gap within the mouthpiece 102 which acts as a cooling section. The air gap provides a chamber through which heated volatilized components generated by the aerosol-generating component 103 flow. The cooling section 108 is hollow to provide a chamber for aerosol accumulation yet rigid enough to withstand axial compressive forces and bending moments that might arise during manufacture and whilst the article 100 is in use. The cooling section 108 provides a physical displacement between the aerosol-generating material 103 and the body of material 106. The physical displacement provided by the cooling section 108 can provide a thermal gradient across the length of the cooling section 108.

In some embodiments, the mouthpiece 102 comprises a cavity having an internal volume greater than 110 mm³. Providing a cavity of at least this volume has been found to enable the formation of an improved aerosol. For example, the mouthpiece 102 comprises a cavity, for instance formed within the cooling section 108, having an internal volume greater than 110 mm³, and such as greater than 130 mm³, allowing further improvement of the aerosol. In some examples, the internal cavity comprises a volume of between about 130 mm³ and about 230 mm³, for instance about 134 mm³ or 227 mm³.

The cooling section 108 can be configured to provide a temperature differential of at least 40 degrees Celsius between a heated volatilized component entering a first, upstream end of the cooling section 108 and a heated volatilized component exiting a second, downstream end of the cooling section 108. The cooling section 108 can be configured to provide a temperature differential of at least 60 degrees Celsius, such as at least 80 degrees Celsius and for example at least 100 degrees Celsius between a heated volatilized component entering a first, upstream end of the cooling section 108 and a heated volatilized component exiting a second, downstream end of the cooling section 108. This temperature differential across the length of the cooling section 108 protects the temperature sensitive body of material 106 from the high temperatures of the aerosol-generating material 103 when it is heated.

The body of material 106 and hollow tubular element 104 each define a substantially cylindrical overall outer shape and share a common longitudinal axis. The body of material 106 is wrapped in a first plug wrap 107. In some embodiments, the first plug wrap 107 has a basis weight of less than 50 gsm, such as between about 20 gsm and 40 gsm. In some embodiments, the first plug wrap 107 has a thickness of between 30 μm and 60 μm, for example between 35 μm and 45 μm. In some embodiments, the first plug wrap 107 is a non-porous plug wrap, for instance having a permeability of less than 100 Coresta units, for instance less than 50 Coresta units. However, in other embodiments, the first plug wrap 107 can be a porous plug wrap, for instance having a permeability of greater than 200 Coresta Units.

In some embodiments, the length of the body of material 106 is less than about 15 mm. For example, the length of the body of material 106 is less than about 12 mm. In addition, or as an alternative, the length of the body of material 106 is at least about 5 mm. In some embodiments, the length of the body of material 106 is at least about 8 mm. In some embodiments, the length of the body of material 106 is from about 5 mm to about 15 mm, such as from about 6 mm to about 12 mm, for example from about 6 mm to about 12 mm, or about 6 mm, 7 mm, 8 mm, 9 mm or 10 mm. In the present example, the length of the body of material 106 is 10 mm.

In the present example, the body of material 106 is formed from filamentary tow. In the present example, the tow used in the body of material 106 has a denier per filament (d.p.f.) of 5 and a total denier of 25,000. In the present example, the tow comprises plasticized cellulose acetate tow. The plasticizer used in the tow comprises about 9% by weight of the tow. In the present example, the plasticizer is triacetin. In other examples, different materials can be used to form the body of material 106. For instance, rather than tow, the body 106 can be formed from paper, for instance in a similar way to paper filters known for use in cigarettes. For instance, the paper, or other cellulose-based material, can be provided as one or more portions of sheet material which is folded and/or crimped to form body 106. The sheet material can have a basis weight of from 15 gsm to 60 gsm, for instance between 20 and 50 gsm. The sheet material can, for instance, have a basis weight in any of the ranges between 15 and 25 gsm, between 25 and 30 gsm, between 30 and 40 gsm, between 40 and 45 gsm and between 45 and 50 gsm. Additionally or alternatively, the sheet material can have a width of between 50 mm and 200 mm, for instance between 60 mm and 150 mm, or between 80 mm and 150 mm. For instance, the sheet material can have a basis weight of between 20 and 50 gsm and a width between 80 mm and 150 mm. This can, for instance, enable the cellulose-based bodies to have appropriate pressure drops for an article having dimensions as described herein.

Alternatively, the body 106 can be formed from tows other than cellulose acetate, for instance polylactic acid (PLA), other materials described herein for filamentary tow or similar materials. The tow can be formed from cellulose acetate. The tow, whether formed from cellulose acetate or other materials, can have a d.p.f. of at least 5. In some embodiments, to achieve a sufficiently uniform body of material 106, the tow has a denier per filament of no more than 12 d.p.f., such as no more than 11 d.p.f. and for example no more than 10 d.p.f.

The total denier of the tow forming the body of material 106 can be at most 30,000, such as at most 28,000 and for example at most 25,000. These values of total denier provide a tow which takes up a reduced proportion of the cross sectional area of the mouthpiece 102 which results in a lower pressure drop across the mouthpiece 102 than tows having higher total denier values. For appropriate firmness of the body of material 106, the tow can have a total denier of at least 8,000 and for example at least 10,000. In some embodiments, the denier per filament is between 5 and 12 while the total denier is between 10,000 and 25,000. In some embodiments the cross-sectional shape of the filaments of tow are ‘Y’ shaped, although in other embodiments other shapes such as ‘X’ shaped filaments can be used, with the same d.p.f. and total denier values as provided herein.

Irrespective of the material used to form the body 106, the pressure drop across body 106, can, for instance, be between 0.3 and 5 mmWG per mm of length of the body 106, for instance between 0.5 mmWG and 2 mmWG per mm of length of the body 106. The pressure drop can, for instance, be between 0.5 and 1 mmWG/mm of length, between 1 and 1.5 mmWG/mm of length or between 1.5 and 2 mmWG/mm of length. The total pressure drop across body 106 can, for instance, be between 3 mmWG and 8 mmWG, or between 4 mmWG and 7 mmWG. The total pressure drop across body 106 can be about 5, 6 or 7 mmWG.

As shown in FIG. 7, the mouthpiece 102 of the article 100 comprises an upstream end 102a adjacent to the aerosol-generating component 103 and a downstream end 102b distal from the aerosol-generating component 103. At the downstream end 102b, the mouthpiece 102 has a hollow tubular element 104 formed from filamentary tow. This has advantageously been found to significantly reduce the temperature of the outer surface of the mouthpiece 102 at the downstream end 102b of the mouthpiece which comes into contact with a consumer's mouth when the article 100 is in use. In addition, the use of the tubular element 104 has also been found to significantly reduce the temperature of the outer surface of the mouthpiece 102 even upstream of the tubular element 104. Without wishing to be bound by theory, it is hypothesized that this is due to the tubular element 104 channeling aerosol closer to the center of the mouthpiece 102, and therefore reducing the transfer of heat from the aerosol to the outer surface of the mouthpiece 102.

The “wall thickness” of the hollow tubular element 104 corresponds to the thickness of the wall of the tube 104 in a radial direction. This may be measured, for example, using a caliper. The wall thickness can be greater than 0.9 mm, such as 1.0 mm or greater. In some embodiments, the wall thickness is substantially constant around the entire wall of the hollow tubular element 104. However, where the wall thickness is not substantially constant, the wall thickness can be greater than 0.9 mm at any point around the hollow tubular element 104, such as 1.0 mm or greater. In the present example, the wall thickness of the hollow tubular element 104 is about 1.3 mm.

In some embodiments, the length of the hollow tubular element 104 is less than about 20 mm. For example, the length of the hollow tubular element 104 can be less than about 15 mm. In some embodiments, the length of the hollow tubular element 104 is less than about 10 mm. In addition, or as an alternative, the length of the hollow tubular element 104 is at least about 5 mm. In some embodiments, the length of the hollow tubular element 104 is at least about 6 mm. In some embodiments, the length of the hollow tubular element 104 is from about 5 mm to about 20 mm, such as from about 6 mm to about 10 mm, for example from about 6 mm to about 8 mm, in particular about 6 mm, 7 mm or about 8 mm. In the present example, the length of the hollow tubular element 104 is 7 mm.

In some embodiments, the density of the hollow tubular element 104 is at least about 0.25 grams per cubic centimeter (g/cc), such as at least about 0.3 g/cc. In some embodiments, the density of the hollow tubular element 104 is less than about 0.75 grams per cubic centimeter (g/cc), for example less than 0.6 g/cc. In some embodiments, the density of the hollow tubular element 104 is between 0.25 and 0.75 g/cc, such as between 0.3 and 0.6 g/cc, and for example between 0.4 g/cc and 0.6 g/cc or about 0.5 g/cc. These densities have been found to provide a good balance between improved firmness afforded by denser material and the lower heat transfer properties of lower density material. For the purposes of the present disclosure, the “density” of the hollow tubular element 104 refers to the density of the filamentary tow forming the element with any plasticizer incorporated. The density may be determined by dividing the total weight of the hollow tubular element 104 by the total volume of the hollow tubular element 104, wherein the total volume can be calculated using appropriate measurements of the hollow tubular element 104 taken, for example, using calipers. Where necessary, the appropriate dimensions may be measured using a microscope.

The filamentary tow forming the hollow tubular element 104 can have a total denier of less than 45,000, such as less than 42,000. This total denier has been found to allow the formation of a tubular element 104 which is not too dense. In some embodiments, the total denier is at least 20,000, such as at least 25,000. In some embodiments, the filamentary tow forming the hollow tubular element 104 has a total denier between 25,000 and 45,000, such as between 35,000 and 45,000. In some embodiments the cross-sectional shape of the filaments of tow are ‘Y’ shaped, although in other embodiments other shapes such as ‘X’ shaped filaments can be used.

The filamentary tow forming the hollow tubular element 104 can have a denier per filament of greater than 3. This denier per filament has been found to allow the formation of a tubular element 104 which is not too dense. In some embodiments, the denier per filament is at least 4, for example at least 5. In some embodiments, the filamentary tow forming the hollow tubular element 104 has a denier per filament between 4 and 10, such as between 4 and 9. In one example, the filamentary tow forming the hollow tubular element 104 has an 7.3Y36,000 tow formed from cellulose acetate and comprising 18% plasticizer, for instance triacetin. The hollow tubular element 104 can have an internal diameter of greater than 3.0 mm.

Smaller diameters than this can result in increasing the velocity of aerosol passing though the mouthpiece 102 to the consumer's mouth more than is desirable, such that the aerosol becomes too warm, for instance reaching temperatures greater than 40° C. or greater than 45° C. In some embodiments, the hollow tubular element 104 has an internal diameter of greater than 3.1 mm, and for example greater than 3.5 mm or 3.6 mm. In one embodiment, the internal diameter of the hollow tubular element 104 is about 4.7 mm.

The hollow tubular element 104 can comprise from 15% to 22% by weight of plasticizer. For cellulose acetate tow, the plasticizer can be triacetin, although other plasticizers such as polyethelyne glycol (PEG) can be used. In some embodiments, the hollow tubular element 104 comprises from 16% to 20% by weight of plasticizer, for instance about 17%, about 18% or about 19% plasticizer.

In the present example, the first hollow tubular element 104, body of material 106 and second hollow tubular element 108 are combined using a second plug wrap 109 which is wrapped around all three sections. In some embodiments, the second plug wrap 109 has a basis weight of less than 50 gsm, such as between about 20 gsm and 45 gsm. In some embodiments, the second plug wrap 109 has a thickness of between 30 μm and 60 μm, such as between 35 μm and 45 μm. The second plug wrap 109 can be a non-porous plug wrap having a permeability of less than 100 Coresta Units, for instance less than 50 Coresta Units. However, in alternative embodiments, the second plug wrap 109 can be a porous plug wrap, for instance having a permeability of greater than 200 Coresta Units.

In the present example, the article 100 has an outer circumference of about 23 mm. In other examples, the article can be provided in any of the formats described herein, for instance having an outer circumference of between 20 mm and 26 mm. Since the article is to be heated to release an aerosol, improved heating efficiency can be achieved using articles having lower outer circumferences within this range, for instance circumferences of less than 23 mm. To achieve improved aerosol via heating, while maintaining a suitable product length, article circumferences of greater than 19 mm have also been found to be particularly effective. Articles having circumferences of between 20 mm and 24 mm, such as between 20 mm and 23 mm, have been found to provide a good balance between providing effective aerosol delivery while allowing for efficient heating. The aerosol-generating component 103 can have a length less than about 25 mm, such as less than about 20 mm, for example less than about 15 mm. In the present example, the aerosol-generating component 103 has a length of about 12 mm.

The article has a ventilation level of about 10% of the aerosol drawn through the article. In alternative embodiments, the article can have a ventilation level of between 1% and 20% of aerosol drawn through the article, for instance between 1% and 12%. Ventilation at these levels helps to increase the consistency of the aerosol inhaled by the user at the mouth end 102b, while assisting the aerosol cooling process. The ventilation is provided directly into the mouthpiece 102 of the article 100. In the present example, the ventilation is provided into the cooling section 108, which has been found to be particularly beneficial in assisting with the aerosol generation process. The ventilation is provided via perforations 112, in the present case formed as a single row of laser perforations, positioned 13 mm from the downstream, mouth-end 102b of the mouthpiece 102. In alternative embodiments, two or more rows of ventilation perforations may be provided. These perforations pass though the tipping paper 105, second plug wrap 109 and cooling section 108. In alternative embodiments, the ventilation can be provided into the mouthpiece at other locations, for instance into the body of material 106 or first tubular element 104. In some embodiments, the article is configured such that the perforations are provided about 28 mm or less from the upstream end of the article 100, such as between 20 mm and 28 mm from the upstream end of the article 100. In the present example, the apertures are provided about 25 mm from the upstream end of the article.

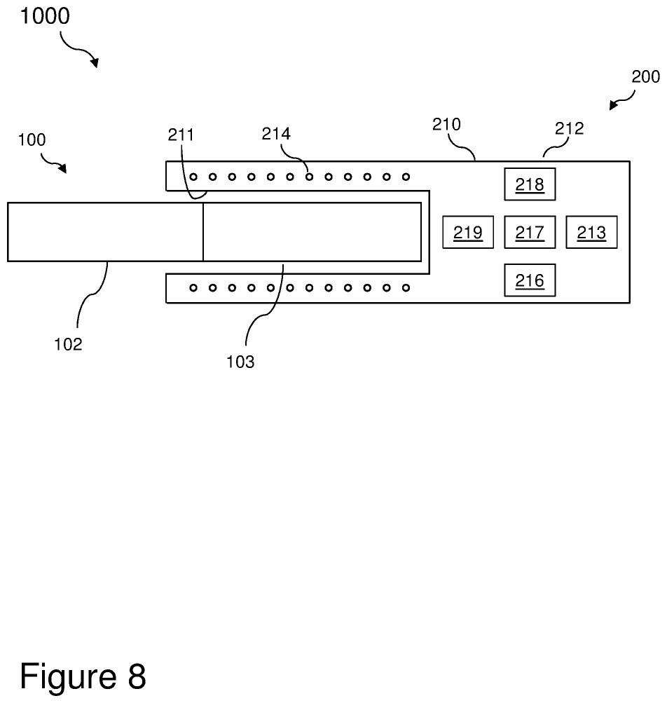

FIG. 8 shows a schematic cross-sectional side view of an example of a system according to an embodiment of the disclosure. The system 1000 comprises an article 100 and a non-combustible aerosol provision device 200. In the present example, the article 100 is the article shown in FIG. 7. In other examples, the article 100 may comprise any one of the aerosol-generating components described herein.

The non-combustible aerosol provision device 200 comprises a body 210 and a heating zone 211 for receiving the article 100. The non-combustible aerosol provision device 200 also comprises a magnetic field generator 212 configured to generate a varying magnetic field for penetrating the heating material of the article 100 when the article 100 is located in the heating zone 211.

The device 200 may include an air inlet (not shown) that fluidly connects the heating zone 211 with the exterior of the device 200. Such an air inlet may be defined by the body 210. A user may be able to inhale aerosol generated by the aerosol-generating material of the article 100 by drawing the aerosol through the mouthpiece 102 of the article 100. As the aerosol is removed from the article 100, air may be drawn into the heating zone 211 via the air inlet of the device 200.

In the present example, the body 210 comprises the heating zone 211. In this example, the heating zone 211 comprises a recess for receiving at least a portion of the article 100. In other examples, the heating zone 211 may be a shelf, a surface, or a projection, and may require mechanical mating with the article in order to co-operate with, or receive, the article. In this example, the heating zone 211 is elongate, and is sized and shaped to accommodate a portion of the article 100. In other examples, the heating zone 211 may be dimensioned to receive the whole article.

In the present example, the magnetic field generator 212 comprises an electrical power source 213, a coil 214, a device 216 for passing a varying electrical current, such as an alternating current, through the coil 214, a controller 217, and a user interface 218 for user-operation of the controller 217.

In the present example, the electrical power source 213 is a rechargeable battery. In other examples, the electrical power source 213 may be other a non-rechargeable battery, a capacitor, a battery-capacitor hybrid, or a connection to a mains electricity supply.

The coil 214 may take any suitable form. In the present example, the coil 214 is a helical coil of electrically-conductive material, such as copper. In some examples, the magnetic field generator 212 may comprise a magnetically permeable core around which the coil 214 is wound. Such a magnetically permeable core concentrates the magnetic flux produced by the coil 214 in use and generates a more powerful magnetic field. The magnetically permeable core may be made of iron, for example. In some examples, the magnetically permeable core may extend only partially along the length of the coil 214, so as to concentrate the magnetic flux only in certain regions. In some examples, the coil may be a flat coil. That is, the coil may be a two-dimensional spiral. In the present example, the coil 214 encircles the heating zone 211. The coil 214 extends along a longitudinal axis that is substantially aligned with a longitudinal axis of the heating zone 211. The aligned axes are coincident. In other examples, the aligned axes may be parallel or oblique to each other.

In the present example, the device 216 for passing a varying current through the coil 214 is electrically connected between the electrical power source 213 and the coil 214. In this example, the controller 217 also is electrically connected to the electrical power source 213, and is communicatively connected to the device 216 in order to control the device 216. More specifically, in this example, the controller 217 is configured to control the device 216, so as to control the supply of electrical power from the electrical power source 213 to the coil 214. In this example, the controller 217 comprises an integrated circuit (IC), such as an IC on a printed circuit board (PCB). In other examples, the controller 217 may take a different form. In some examples, the non-combustible aerosol provision device may have a single electrical or electronic component comprising the device 216 and the controller 217.

In the present example, the controller 217 is operated by user-operation of the user interface 218. In this example, the user interface 218 is located at the exterior of the body 210. The user interface 218 may comprise a push-button, a toggle switch, a dial, a touchscreen, or the like. In other examples, a user interface remote from the non-combustible aerosol provision device may be provided. Such a user interface may be connected to the non-combustible aerosol provision device using a wireless communication method, such as Bluetooth. For example, the user interface may be implemented as part of a mobile electronic device, such as a mobile phone, which is able to communicate with the non-combustible aerosol provision device using a wireless communication method, such as Bluetooth. A user may be able to remotely control the non-combustible aerosol provision device using the user interface of their mobile phone.

In the present example, operation of the user interface 218 by a user causes the controller 217 to cause the device 216 to cause an alternating electrical current to pass through the coil 214. This causes the coil 214 to generate an alternating magnetic field. The coil 214 and the heating zone 211 of the non-combustible aerosol provision device 200 are suitably relatively positioned so that, when the article 100 is located in the heating zone 211, the varying magnetic field produced by the coil 214 penetrates the heating material of the article 100. In the present example, the varying magnetic field produced by the coil 214 penetrates the heating material of the aerosol-generating component 103.

In some examples, the heating material of the article is an electrically-conductive material, such as aluminum foil. In such examples, penetration of the heating material by a magnetic field causes the generation of one or more eddy currents in the heating material. The flow of eddy currents in the heating material against the electrical resistance of the heating material causes the heating material to be heated by Joule heating. In some examples, the heating material is a magnetic material, such as ferromagnetic stainless steel, for instance type 430 stainless steel. In such examples, the orientation of magnetic dipoles in the heating material changes with the changing applied magnetic field, which causes heat to be generated in the heating material.

The non-combustible aerosol provision device 200 comprises a temperature sensor 219 configured to sense a temperature of the heating zone 211. The temperature sensor 219 is communicatively connected to the controller 217, so that the controller 217 is able to monitor the temperature of the heating zone 211. On the basis of one or more signals received from the temperature sensor 219, the controller 217 may cause the device 216 to adjust a characteristic of the varying or alternating electrical current passed through the coil 214 as necessary, in order to ensure that the temperature of the heating zone 211 remains within a predetermined temperature range. The characteristic may be, for example, amplitude or frequency or duty cycle. Within the predetermined temperature range, in use the aerosol-generating material within an article located in the heating zone 211 is heated sufficiently to volatilize at least one component of the aerosol-generating material without combusting the aerosol-generating material. Accordingly, the controller 217, and the device 200 as a whole, is arranged to heat the aerosol-generating to volatilize the at least one component of the aerosol-generating material without combusting the aerosol-generating. In some embodiments, the temperature range is about 50° C. to about 300° C., such as between about 50° C. and about 250° C., between about 50° C. and about 150° C., between about 50° C. and about 120° C., between about 50° C. and about 100° C., between about 50° C. and about 80° C., or between about 60° C. and about 70° C. In some embodiments, the temperature range is between about 170° C. and about 220° C. In other embodiments, the temperature range may be other than this range. In some embodiments, the upper limit of the temperature range could be greater than 300° C. In some embodiments, the temperature sensor 219 may be omitted. In some embodiments, the heating material may have a Curie point temperature selected on the basis of the maximum temperature to which it is desired to heat the heating material, so that further heating above that temperature by induction heating the heating material is hindered or prevented.

Also presented herein is a method of manufacturing an aerosol-generating component for use with a non-combustible aerosol provision device. The method is shown in FIG. 8 and comprises providing a first sheet comprising aerosol-generating material (S101); providing a second sheet comprising heating material (S102); and wrapping the first sheet and the second sheet in a wrapper (S103). The wrapper comprises paper and has a permeability below 500 Coresta units.

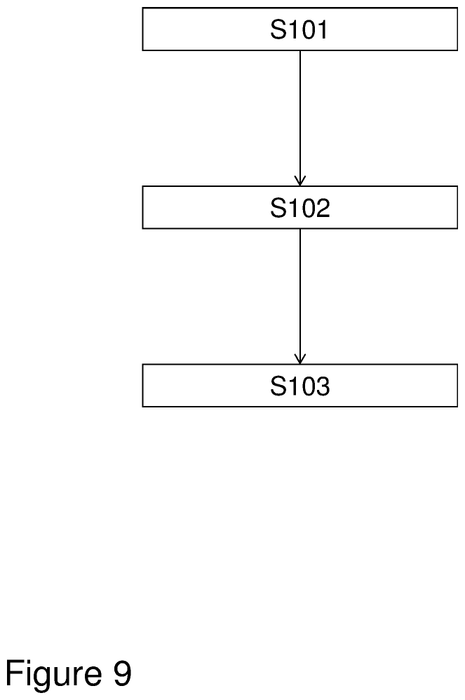

Also presented herein is a method of manufacturing an aerosol-generating component for use with a non-combustible aerosol provision device. The method is shown in FIG. 9 and comprises forming a sheet of laminate material, the sheet comprising a first layer comprising aerosol-generating material and a second layer comprising heating material (S201); and shredding the sheet to form a plurality of strips of laminate material (S202). Each of the plurality of strips comprises a first layer comprising aerosol-generating material and a second layer comprising heating material.

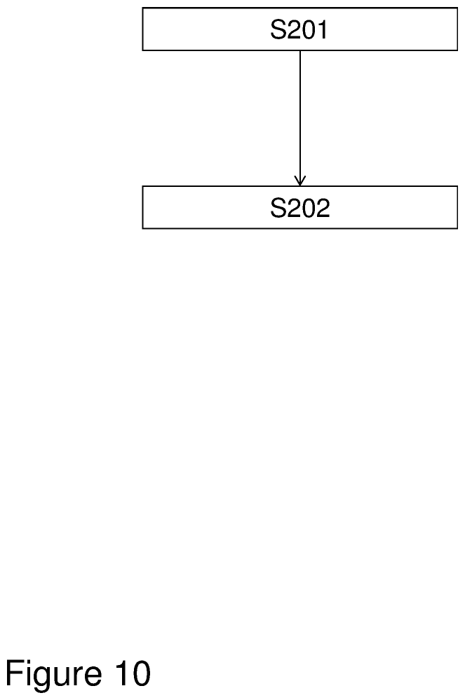

Also presented herein is a method of manufacturing an aerosol-generating component for use with a non-combustible aerosol provision device. The method is shown in FIG. 10 and comprises shredding a first sheet of aerosol-generating material to form a first plurality of strips (S301); and shredding a second sheet of heating material to form a second plurality of strips (S302).

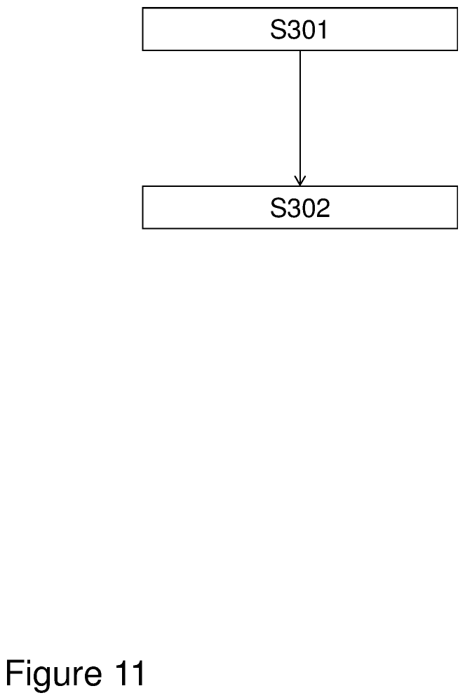

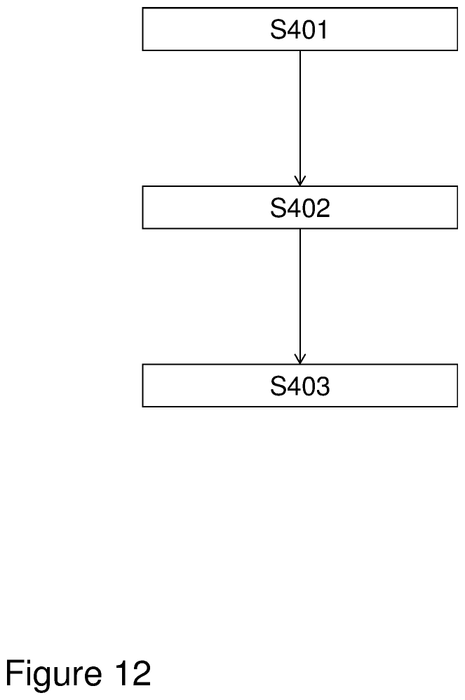

Also presented herein is a method of manufacturing an aerosol-generating component for use with a non-combustible aerosol provision device. The method is shown in FIG. 11 and comprises providing a core section comprising a first aerosol-generating material (S401); disposing a boundary material around the core section (S402); and disposing a sheath section around the core section, the sheath section comprising a second aerosol-generating material (S402). The boundary material is disposed between the core section and the sheath section. As mentioned above, boundary material 16 can be formed into a continuous tube of sheet material and/or heating material and, in manufacture of the component 1′″, for instance continuously wrapping the core section at S401. The second aerosol-generating material can be a plurality of strips of aerosol-generating material, such as reconstituted tobacco material, and the boundary material 16 and optional core section 14 can be fed as a continuous tube into a continuous supply of the strips and then wrapped in the outer wrapper 20 (S402). The boundary material 16 can be fed as an elongate sheet with is bent to form a tube and then welded and/or otherwise mechanically and/or electrically connected at the seam in an ‘online’ process, shortly before the tube is inserted into the second aerosol-generating material. The tube can be filled or partially filled with the first aerosol-generating material during this process (i.e., immediately prior to forming the tube from the elongate sheet of boundary material), or once the process is complete and the tube is embedded within the second aerosol-generating material. Alternatively, the tube can remain hollow and form a boundary between the second aerosol-generating material and an internal cavity extending through the component 1′″.

Articles, for instance those in the shape of rods, are often named according to the product length: “regular” (typically in the range 68-75 mm, e.g. from about 68 mm to about 72 mm), “short” or “mini” (68 mm or less), “king size” (typically in the range 75-91 mm, e.g. from about 79 mm to about 88 mm), “long” or “super-king” (typically in the range 91-105 mm, e.g. from about 94 mm to about 101 mm) and “ultra-long” (typically in the range from about 110 mm to about 121 mm).

They are also named according to the product circumference: “regular” (about 23-25 mm), “wide” (greater than 25 mm), “slim” (about 22-23 mm), “demi-slim” (about 19-22 mm), “super-slim” (about 16-19 mm), and “micro-slim” (less than about 16 mm).

Accordingly, an article in a king-size, super-slim format will, for example, have a length of about 83 mm and a circumference of about 17 mm.

Each format may be produced with mouthpieces of different lengths. The mouthpiece length will be from about 30 mm to 50 mm. A tipping paper connects the mouthpiece to the aerosol generating material and will usually have a greater length than the mouthpiece, for example from 3 to 10 mm longer, such that the tipping paper covers the mouthpiece and overlaps the aerosol generating material, for instance in the form of a rod of substrate material, to connect the mouthpiece to the rod.

Articles and their aerosol generating materials and mouthpieces described herein can be made in, but are not limited to, any of the above formats.

In some embodiments, the substance to be delivered may be an aerosol-generating material or a material that is not intended to be aerosolized. As appropriate, either material may comprise one or more active constituents, one or more flavors, one or more aerosol-former materials, and/or one or more other functional materials.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. The total amount of aerosol-former material provided can be in the range of 10% to 30%, for instance 12% to 22%, by weight, of the aerosol generating material, such as tobacco material.

The one or more other functional materials may comprise one or more of pH regulators, coloring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent.

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel.

The aerosol-modifying agent may be in powder, thread or granule form. The aerosol-modifying agent may be free from filtration material.

As used herein, the term “tobacco material” refers to any material comprising tobacco or derivatives or substitutes thereof. The term “tobacco material” may include one or more of tobacco, tobacco derivatives, expanded tobacco, reconstituted tobacco or tobacco substitutes. The tobacco material may comprise one or more of ground tobacco, tobacco fiber, cut tobacco, extruded tobacco, tobacco stem, tobacco lamina, reconstituted tobacco and/or tobacco extract.

In some embodiments, the substance to be delivered comprises an active substance. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco or another botanical. In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens.

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor. As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the disclosure as defined by the claims or limitations on equivalents to the claims, and that other embodiments may be utilized and modifications may be made without departing from the scope of the disclosure. Various embodiments of the disclosure may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol-generating component for use with a non-combustible aerosol-provision device, the aerosol-generating component comprising:
a first sheet comprising aerosol-generating material;
a second sheet comprising heating material that is heatable by penetration with a varying magnetic field; and
a wrapper comprising paper and circumscribing the first sheet and the second sheet, wherein the wrapper has a permeability below 500 Coresta units.

2. The aerosol-generating component according to claim 1, wherein a surface of the first sheet is in contact with a surface of the second sheet.

3. The aerosol-generating component according to claim 1, wherein at least one of:
the first sheet has a thickness between about 100 μm and about 300 μm, or
the second sheet has a thickness between about 1 μm and about 150 μm.

4. The aerosol-generating component according to claim 1, wherein either:
the aerosol-generating component further comprises an adhesive bonding the first sheet and the second sheet together, or
the first sheet and the second sheet are free of adhesive.

5. The aerosol-generating component according to claim 1, wherein the first sheet comprises a plurality of apertures or a plurality of embossed portions.

6. The aerosol-generating component according to claim 1, wherein a total area of the first sheet is greater or less than a total area of the second sheet.

7. An aerosol-generating component for use with non-combustible aerosol provision device, the aerosol-generating component comprising:
a plurality of strips of laminate material, each of the plurality of strips of laminate material comprising:
a first layer comprising aerosol-generating material and
a second layer comprising heating material that is heatable by penetration with a varying magnetic field.

8. The aerosol-generating component according to claim 7, wherein the aerosol-generating component has a longitudinal axis, and the plurality of strips of laminate material are substantially aligned with the longitudinal axis.

9. The aerosol-generating component according to claim 7, wherein each of the plurality of strips of laminate material has a length between about 10 mm and about 60 mm.

10. The aerosol-generating component according to claim 7, wherein each of the plurality of strips of laminate material has a width between about 0.9 mm and about 2 mm.

11. The aerosol-generating component according to claim 7, wherein each of the plurality of strips of laminate material has a thickness between about 100 μm and about 300 μm.

12. The aerosol-generating component according to claim 7, wherein each of the plurality of strips of laminate material is substantially rectangular.

13. The aerosol-generating component according to claim 7, wherein each of the plurality of strips of laminate material comprises an adhesive bonding the first layer to the second layer.

14. An aerosol-generating component for use with a non-combustible aerosol provision device, the aerosol-generating component comprising:
a first plurality of strips of aerosol-generating material; and
a second plurality of strips of heating material that is heatable by penetration with a varying magnetic field.

15. The aerosol-generating component according to claim 14, wherein the second plurality of strips of heating material are dispersed within the first plurality of strips of aerosol-generating material.

16. The aerosol-generating component according to claim 14, wherein the aerosol-generating component has a longitudinal axis, and at least one of the first plurality of strips of heating material or the second plurality of strips of aerosol-generating material are substantially aligned with the longitudinal axis.

17. The aerosol-generating component according to claim 14, wherein at least one of each of the first plurality of strips of heating material or the second plurality of strips of aerosol-generating material has a length between about 10 mm and about 60 mm.

18. The aerosol-generating component according to claim 14, wherein at least one of each of the first plurality of strips of heating material or the second plurality of strips of aerosol-generating material has a width between about 0.9 mm and about 2 mm.

19. The aerosol-generating component according to claim 14, wherein at least one of each of the first plurality of strips of heating material or the second plurality of strips of aerosol-generating material has a thickness between about 1 μm and about 150 μm.

20. The aerosol-generating component according to claim 14, wherein at least one of:
one or both of each of the first plurality of strips of heating material or each of the second plurality of strips of aerosol-generating material is substantially rectangular, or
one or both of each of the first plurality of strips of heating material or each of the second plurality of strips of aerosol-generating material is free of adhesive.

21. An aerosol-generating component for use with non-combustible aerosol provision device, the aerosol-generating component comprising:
a core section comprising a first aerosol-generating material or a cavity;
a sheath section comprising a second aerosol-generating material, wherein the sheath section surrounds the core section; and
a boundary material surrounding the core section, wherein the boundary material is between the core section and the sheath section.

22. The aerosol-generating component according to claim 21, wherein a characteristic of the first aerosol-generating material is different from a characteristic of the second aerosol-generating material.

23. The aerosol-generating component according to claim 22, wherein the characteristic is at least one of density, type, or flavor.

24. The aerosol-generating component according to claim 21, wherein:
at least one of:
the core section comprises a plurality of strips of the first aerosol-generating materials, or
the sheath section comprises a plurality of strips of the second aerosol-generating material; or, wherein
the core section comprises lamina tobacco in the form of cut rag tobacco and the sheath section comprises reconstituted tobacco sheet material.

25. The aerosol-generating component according to claim 21, wherein the boundary material is in contact with at least one of the first aerosol-generating material or the second aerosol-generating material.

26. The aerosol-generating component according to claim 21, wherein the boundary material is at least one of porous, or comprises a plurality of apertures.

27. The aerosol-generating component according to claim 21, wherein the core section has a diameter between about 4 mm and about 6 mm.

28. The aerosol-generating component according to claim 21, wherein at least one of:
the sheath section has a thickness between about 100 μm and about 300 μm, wherein
the sheath section has a thickness of greater than 200 μm, or
the boundary material has a thickness between about 1 μm and about 150 μm.

29. The aerosol-generating component according to claim 21, wherein at least one of:
the core section is substantially cylindrical, or
the sheath section is substantially tubular.

30. The aerosol-generating component according to claim 21, wherein at least one of:
the boundary material defines one or more airflow pathways extending in a direction parallel to a longitudinal axis of the aerosol-generating components, or
the boundary material is a corrugated sheet material.

31. The aerosol-generating component according to claim 21, wherein at least one of the boundary material or the sheath section comprises a heating material.

32. The aerosol-generating component according to claim 1, wherein the heating material comprises at least one of an electrically-conductive material or a magnetic material.

33. The aerosol-generating component according to claim 1, wherein the heating material comprises a metal or a metal alloy.

34. An aerosol-generating component according to claim 33, wherein the heating material comprises stainless steel or aluminum.

35. The aerosol-generating component according to claim 21, wherein an outer diameter of the core section or an outer diameter of the cavity is one of the following with respect to an outer diameter of the sheath section:
between about 30% and about 70%,
between about 40% and about 60% or
between about 45% and about 55%.

36. The aerosol-generating component according to claim 21, wherein an outer diameter of the core section or an outer diameter of the cavity is one of the following with respect to an outer diameter of the sheath section:
between about 60% and about 80%,
between about 65% and about 75% or
about 70%.

37. The aerosol-generating component according to claim 1, wherein the aerosol-generating material is reconstituted, cellulosic, or in gel form.

38. The aerosol-generating component according to claim 1, wherein the aerosol-generating material comprises tobacco material.

39. The aerosol-generating component according to claim 1, wherein the aerosol-generating component is substantially cylindrical.

40. The article for use with a non-combustible aerosol provision device, the article comprising the component according to claim 1.

41. A non-combustible aerosol delivery system comprising:
a non-combustible aerosol provision device; and
the component according to claim 1.

42. A method of manufacturing an aerosol-generating component for use with a non-combustible aerosol provision device, the method comprising:
providing a first sheet comprising aerosol-generating material;
providing a second sheet comprising heating material that is heatable by penetration with a varying magnetic field; and
wrapping the first sheet and the second sheet in a wrapper, wherein the wrapper comprises paper and has a permeability below 500 Coresta units.

43. A method of manufacturing an aerosol-generating component for use with a non-combustible aerosol provision device, the method comprising:
forming a sheet of laminate material, the sheet of laminate material comprising a first layer comprising aerosol-generating material and a second layer comprising heating material that is heatable by penetration with a varying magnetic field; and
shredding the sheet of laminate material to form a plurality of strips of laminate material, each of the plurality of strips of laminate material comprising:
the first layer comprising the aerosol-generating material and
the second layer comprising the heating material that is heatable by penetration with the varying magnetic field.

44. A method of manufacturing an aerosol-generating component for use with a non-combustible aerosol provision device, the method comprising:
shredding a first sheet of aerosol-generating material to form a first plurality of strips; and
shredding a second sheet of heating material to form a second plurality of strips, wherein the heating material is heatable by penetration with a varying magnetic field.

45. A method of manufacturing an aerosol-generating component for use with a non-combustible aerosol provision device, the method comprising:
providing a core section;
disposing a boundary material around the core section; and
disposing a sheath section around the core section, the sheath section comprising an aerosol-generating material;
wherein the boundary material is disposed between the core section and the sheath section.

46. The method according to claim 45, wherein disposing the sheath section around the core section comprises feeding the boundary material and the core section continuously into a supply of the aerosol-generating material.

47. The method according to claim 45, wherein disposing the boundary material around the core section comprises wrapping the boundary material around the core section.
